(19) United States
(12) Patent Application Publication
(10) Pub. No.: US 2006/0136252 A1
(43) Pub. Date: Jun. 22, 2006

(54) Method for handling and tracking baggage

(76) Inventors: Thomas Jenkins, Voorhees, NJ (US); Ishaq Samai, Sicklerville, NJ (US)

Correspondence Address: DUANE MORRIS, LLP;IP DEPARTMENT, 30 SOUTH 17TH STREET, PHILADELPHIA, PA, 19103-4196, US

(21) Appl. No.: 11/273,557

(22) Filed: Nov. 14, 2005

Related U.S. Application Data
(60) Provisional application No. 60/628,521, filed on Nov. 15, 2004.

(51) Int. Cl. G06Q 99/00; G06F 7/00; G08B 13/24

(52) U.S. Cl. 705/1; 705/28; 700/213; 340/551

(57) ABSTRACT

A method for handling baggage comprises the steps of: (a) collecting at least one piece of baggage from an off-airport site designated by at least one passenger, the collecting being performed by an agent of a commercial shipping business; (b) delivering the collected piece of baggage to an off-airport site; (c) scanning the delivered piece of baggage for tracking; and (d) delivering the scanned piece of baggage to at least one airport.

This application claims the benefit of U.S. Provisional Patent Application No. 60/628,521, filed Nov. 15, 2005, which is expressly incorporated by reference herein in its entirety.

### FIELD OF THE INVENTION

The present invention relates to methods for handling baggage and baggage for airline travel.

### BACKGROUND

On Sep. 11, 2001 the United States sustained an unprecedented terrorist attack. Four hijacked planes were used as missiles, completely destroying the World Trade Center and partly destroying the Pentagon. Understandably, the public was in a state of shock. In the wake of these attacks commercial airline travel dropped precipitously and the federal government instituted new passengers and baggage screening procedures. With the passage of time the flying public's faith has not been restored for a variety of reasons and the airline industry has undergone fundamental change.

The already precarious financial condition of the major airline carries grew much worse after 9/11. In 2001, airlines lost $7.7 billion and similar amount in 2002. Federal grants eased the situation to some extent. Yet U.S. Airways and United Airlines were forced to file for bankruptcy protection.

In response to reduced demand after 9/11 and stringent competition from low cost airlines, network carries shifted to smaller planes, cut back flying schedules and seating capacity and implemented cost cutting measures. Among large hub airports which provide the majority of commercial air traffic, the average lost of seats was approximately 12 percent while the average lost of flights was approximately 10 percent. Lay-offs were deep and widespread. Since 9/11 airlines have laid-off at least 80,000 employees. Yet, ultimately cost reductions are not a sustainable solution. Further job losses will only lead to more decline in service. The savings from job cuts will not be nearly enough to replace revenue losses from reduced demand.

Ironically, new security procedures have created the odd spectacle of two hour lead times at the airport for a one hour flight. Frequent delays and long cues at check-in counters and security checkpoints have increased air travel discomfort. Hence, it is no surprise that many travelers now elect to drive distances of six and seven hundred miles rather than experience the inconvenience and anxiety associated with contemporary airline travel. Parenthetically, the Philadelphia Inquirer recently reported on the collapse of the Terminal B-C conveyor belt for outbound checked baggage at the Philadelphia International Airport. This breakdown caused tens of thousands of bags to miss flights. Dozens of passengers reported that it took days or weeks to get their bags returned.

The impact on airports and the tourism industry is yet another cause for alarm. The decline in airline travel after 9/11 precipitated significant reductions in the amount of revenue collected by airports in form of parking fees, taxes, landing fees, lease and concessions. Since U.S. airports are heavily indebted, significant declines in airport revenues threaten the credit ratings of airports' bonded indebtedness. Lowered ratings, in turn, increase interest costs.

During the latter half of the twentieth century the decline of the manufacturing sector greatly impacted the nation's older cities of the northeast and mid-west. Increasingly the new urban economies are based on travel and tourism. Travel and tourism now generated over $250 billion annually among the nation's top 100 cities. The economic value of travel and tourism actually exceeds that of health services, banking and communications.

According to the economic forecasting firm DRI-WEFA, the impact of 9/11 resulted in a loss of $11.7 billion in 2001 and $18.9 billion in 2002 among the nation's twenty largest metropolitan areas. And, apart from the negative impact upon municipally-owned airports, local governments have suffered from declines in tourist-related taxes. A recent study of city finances by the National League of Cities found that for the period from Oct. 1, 2000 through Mar. 31, 2002 revenues from hotel, restaurant and amusement taxes declined approximately 18 percent from conservatively projected amounts. Thus, the municipal stake in reviving air travel and tourism is large indeed.

### SUMMARY OF THE INVENTION

A method for handling baggage comprises the steps of: (a) collecting at least one piece of baggage from an off-airport site designated by at least one passenger, the collecting being performed by an agent of a commercial shipping business; (b) delivering the collected piece of baggage to an off-airport site; (c) scanning the delivered piece of baggage for tracking; and (d) delivering the scanned piece of baggage to at least one airport.

### BRIEF DESCRIPTION OF THE DRAWINGS

FIG. 1 is a flow chart diagram of an embodiment of the invention.

### DETAILED DESCRIPTION

While the foregoing recounts many of the adverse consequences that occurred following the 9/11 tragedy, the status quo can be positively altered. The following section of this paper explains how the confidence of the flying public can be restored and the volume of air travel increased.

One exemplary embodiment includes the creation of baggage pickup service (BPS). The exemplary BPS would allow pickup of baggage from passengers at off-airport locations, or hand-off of baggage to the baggage pickup service provider (BPSP), which is located off the airport grounds. In a preferred embodiment, the BPSP picks up the baggage from the passenger at a location designated by the passenger. Examples of the designated location may include, but are not limited to: the passenger's home or hotel, the passenger's place of employment, the BPSP's place of employment, or a BPSP kiosk located in or adjacent to a convenient commercial establishment, such as an office superstore, a shopping mall, a photocopying center, an industrial park, or the like. The BPS pickup location is convenient, for the purpose of baggage pickup or drop-off, to the flying public.

In one embodiment, a passenger would provide his or her bag or bags to the BPSP at any of the above locations at least about twelve hours before flight departure, preferably during the calendar day before departure. In other embodiments, a shorter time period, such as five, eight hours, ten hours, or anywhere between eight and 12 hours before the departure time. In some embodiments, the individual airports determine the length of time for their respective passengers. Because the baggage is available to the Transportation Safety Authority (TSA) security personnel many hours before departure, the TSA personnel have the flexibility to perform a comprehensive security check on every checked bag. The TSA can use bomb scanning equipment, bomb sniffing dogs, or any other means at its disposal to improve the integrity of airplane security. This, in turn, increases the confidence of the flying public that security concerns are being met.

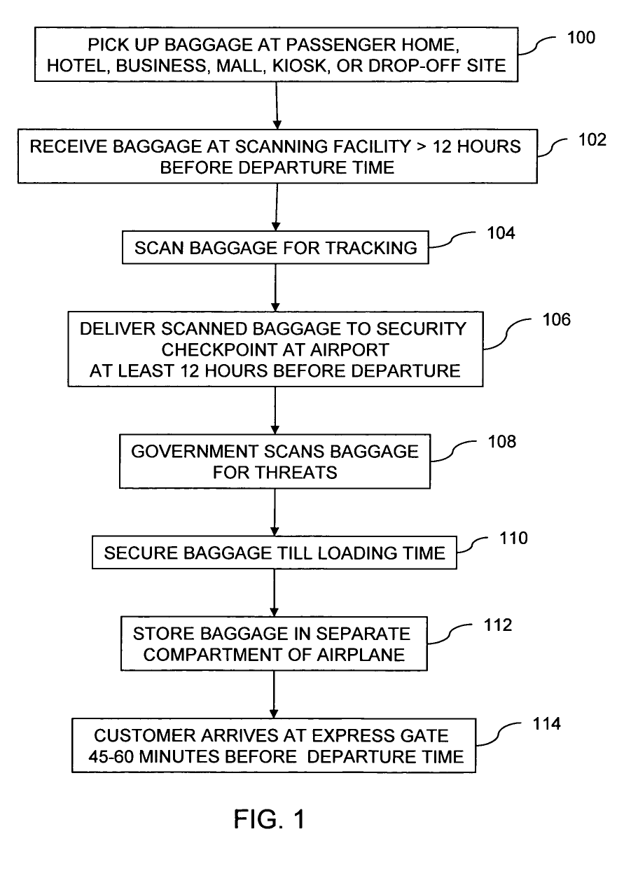

FIG. 1 is a flow chart diagram of an exemplary method.

At step 100, the BPSP picks up the baggage at the passenger's home, hotel, business, a mall, a kiosk, or a drop-off site.

At step 102, the baggage is received at a scanning facility, preferably more than 12 hours before the flight's scheduled departure time.

At step 104, the BPSP scans the baggage for tracking purposes (e.g., using a bar code or other machine readable indicia).

At step 106, the BPSP delivers the scanned baggage to a security checkpoint at the airport, preferably at least 12 hours before the flight's scheduled departure time.

At step 108, the government (Transportation Safety Authority) scans the baggage for security threats.

At step 110, the baggage is secured until time to load the cargo on the plane.

At step 112, the baggage that was picked up and delivered by the BPSP is preferably stored in a compartment of the airplane separate from that used for regular coach passengers.

At step 114, the customer reports to an express gate at a time that is closer to scheduled departure time than the time at which regular airline customers are instructed to report. For example, customers of the BPSP may be permitted to report to the express gate 45 to 60 minutes before flight's scheduled departure time.

### EXAMPLE 1

In one embodiment of a BPS method, the BPSP is a transportation and shipping service provider, such as an express or overnight delivery service (e.g., UPS®, FEDEX®, or DHL). The BPSP may be in the business of transporting packages via ground and/or air transport means, preferably both. Preferably, the BPSP maintains a fleet of ground delivery vehicles for delivery and pickup of letters and/or packages to and from businesses and members of the public. A BPSP maintaining this service will typically maintain a regular set of routes and a fleet of vehicles to collect packages from, and deliver packages to, regular business customer locations, BPSP operated satellite facilities, and kiosks in retail outlets. In addition, the BPSP also delivers packages to recipients located along or near these regular routes. In a preferred embodiment, the BPSP would add baggage pickup to the regular pickup and delivery service along the same route. For example, the BPSP could pick up baggage at a regular business location while delivering daily packages to, or picking up packages from, the BPSP's regular business customer. The BPSP could also pick up baggage at BPSP operated satellite facilities or an annex or window at any BPSP operated facility. The BPSP could also pick up baggage at a kiosk in a location such as a retail outlet, an office superstore, a shopping mall, a photocopying center, or the like. The BPSP could also pick up baggage at houses, apartments, or hotels anywhere along or near its route.

Upon pickup or drop-off, baggage would be checked by personnel (who perform a function similar to that of skycaps, but off of the airport site) and subsequently delivered to the local airport well in advance of a time to be loaded onto the departing flight. In some metropolitan areas, a single BPSP may drop off bags at more than one airport. After bags are picked up by the BPSP, each bag would be scanned for tracking by on-site personnel, for example using optical bar codes.

In some embodiments, the BPSP is an express carrier with an annex, trailer, or separate building to handle the BPS, located adjacent to it regional hub. Upon completion of her route and return to the hub with a combination of packages and/or baggage, the agent (driver) delivers the baggage directly to the BPS annex, trailer or building, where it is scanned (e.g., a bar code is attached and scanned for identification purposes) and entered into a BPS database that is preferably separate from the express carrier service database.

In some embodiments, a first agent of a commercial ground shipping business picks up baggage from an off-airport site—which may be remote from regular delivery routes—designated by a customer, and delivers the picked-up pieces of baggage to a second off-airport site along a regular deliver route, where they are picked up by a second agent during the second agent's regular delivery rounds. This is advantageous where baggage is picked up from passengers at locations that are out of the way for the regular pickup and delivery routes used by the ground/air transportation service operated by the BPSP. These embodiments allow the passenger to have the baggage picked up at home, at a hotel, or at any other site the passenger designates, without increasing the length of the route of the second agent that makes regular deliveries and/or pickups.

Benefits to be gained from the use of BPS's include:

The lead time by which the customer must arrive at the airport prior to departure can drop from 1.5-2.0 hours to 30-45 minutes. Because the baggage has already been delivered to the airport, the passenger need only arrive long enough in advance of the flight to ensure that the passenger herself (and any carry-on baggage) can be checked for security purposes (e.g., metal detection or the like). The amount of time by which a customer must reach the airport prior to the flight can be determined solely by efficient boarding and security considerations. There is no need to force the passenger to arriver earlier just to ensure that there is time to search or scan the passenger's baggage or load the baggage on the plane. Upon arrival at the airport, passengers using the BPS service would proceed directly to a security checkpoint at the departing gate entrance. Preferably, a separate “VIP” passenger security checkpoint would be provided, which would have a much shorter queue than was previously the case for coach or economy class passengers. A separate metal detector queue may be provided for these VIP passengers.

Decreased passenger congestion immediately prior to flight departure allows airline personnel to operate more efficiently.

Decreased flight delays caused by the current baggage check system.

Eliminate or decrease baggage loss occurring on itineraries with connecting flights through more efficient baggage handling. For example, previously, passengers flying form San Francisco to Philadelphia via Dallas frequently failed to receive their checked baggage upon arrival to Philadelphia. When this occurred, the passenger was burdened by having to return to the airport at a later date to obtain their baggage.

The improved airport environment and heightened security through universal baggage checking should lead to increased passenger travel and hence increased airline revenue.

Increased air travel generates more airport revenue.

Increased tourist travel generates more municipal revenue.

Another aspect of the exemplary method is to allow universal scanning of baggage by government security personnel for bombs, harmful chemicals, weapons, or other threats. Because of the 8 (or preferably 12) hour lead time, once the baggage is delivered to the airport, government personnel will have ample opportunity to check adequately and assure the security of each bag. Thus, the flying public can be reasonably assured it is very unlikely an explosive device can be hidden in checked baggage. Further, the increased lead time also provides the opportunity for greater baggage security. Each person who inspects a bag could be required to affix an identifying mark on the bag inspected, thereby diminishing the rate of baggage theft.

When it is time to load the baggage on the airplane, the pieces of baggage delivered by the BPSP may be stored in a BPS area or compartment of the airplane separate from the area or compartment used to store bags that are checked in at the airport. This allows these pieces of baggage to be easily accessed and removed from the plane first, for delivery to the baggage claim area, or to a connecting flight. Thus, customers that take advantage of the BPS service also benefit by having their baggage removed first, providing another incentive for customers to use the service.

### EXAMPLE 2

Another exemplary embodiment includes the creation of baggage drop-off facilities (BDF). The exemplary BDF's would be located off the airport grounds. They would be convenient, for the purpose of baggage drop-off, to the flying public. With the new BDF's a passenger would deliver their bag or bags at least a predetermined amount of time (which may be about five, eight, ten or twelve hours before flight departure), preferably during the calendar day before departure. Upon drop-off, baggage would be checked by personnel (e.g., skycaps) and subsequently delivered to the local airport well in advance of a time to be loaded onto the departing flight. In some metropolitan areas, a single BDF may drop off bags at more than one airport. After bags are dropped off, each bag would be scanned for tracking by on-site personnel, for example using optical bar codes.

In some embodiments, the total amount of time spent at the drop-off facility may be as little as between 5 and 15 minutes, although in other embodiments, the baggage may remain in the drop-off facility longer if it is dropped off more than 12 hours before the scheduled departure time. Ideally, the customers would spend little or no time waiting in line to drop off their baggage. Written procedures can be developed for distribution to BDF customers prior to arrival at the BDF. The written procedures may be distributed via hardcopy, facsimile, electronic mail or by Internet transport using hypertext transport protocol (HTTP). These procedures would explain exactly how the process works enabling drop-off facilities to operate at maximum efficiency.

As in the case of the BPS, use of BDF's allows universal scanning of baggage by government security personnel for bombs, harmful chemicals, weapons, or other threats. Because of the 12 hour lead time, once the baggage is delivered to the airport, government personnel will have ample opportunity to check adequately and assure the security of each bag.

In some embodiments, the BDF's may be located at stations operated by a commercial transport business enterprise, i.e., an express carrier. The BDF's may be operated by the commercial transport business enterprise, or a small business may operate the BDF using rented space.

Program Implementation

With regard to acceptance, there are strong reasons why the flying public would embrace the new arrangement. Driving six or seven hundred miles for the family vacation which generally occurs only once per year is clearly an onerous choice. The expenditure of a small additional premium to relieve the inconvenience and hassle in the current system appears to be a small price to pay. Secondly, the exemplary method addresses many of the security concerns and security-related anxieties felt by many passengers through the introduction of more systematic baggage checking that goes well beyond the current practice of random checks.

The new program could initially be marketed through travel agencies who would be offered financial incentives for getting their clients to try out the new service. Public promotion campaigns that include television, radio and billboard advertisement are additional, proven measures of gaining public acceptance.

The embodiments described herein set forth a program of reform designed to increase airline travel while at the same time improve air travel security. It envisions the cooperation of the air travel industry's major stakeholders: the airlines, state and local government and BPSP's, such as express carriers. An exemplary method includes a change in the travel behavior of airline passengers. In return for an alteration in flying habits, airline travelers will receive a vastly improved flying experience.

Conclusion

The foregoing describes the dramatic changes that have adversely affected airline travel in the wake of 9/11. If nothing is done, the situation may not improve and may grow worse. Nothing less than a bold, innovative approach is called for. The introduction of baggage pickup services and/or baggage drop-off facilities are important solutions. The exemplary methods are designed to 1) revive intermediate and long distance air travel on network airlines; 2) improve airport finances; 3) generate increased municipal revenue through travel-related fees; 4) improve air travel security and 5) generate new jobs.

With the combined efforts of all stakeholders-the airlines, government, ground transportation and the flying public, the likelihood of future terrorist attacks on the airlines can be reduced and the atmosphere of air travel to which the flying public grew accustomed over decades of travel can be restored!

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

What is claimed is:

1. A method for handling baggage, comprising the steps of:
(a) collecting at least one piece of baggage from an off-airport site designated by at least one passenger, the collecting being performed by an agent of a commercial shipping business;
(b) delivering the collected piece of baggage to an off-airport site;
(c) scanning the delivered piece of baggage for tracking; and
(d) delivering the scanned piece of baggage to at least one airport.

2. The method of claim 1, wherein step (a) includes receiving respective pieces of baggage from each of a plurality of passengers during a calendar day before a respective calendar day of the scheduled departure of the respective flight on which that passenger is to fly.

3. The method of claim 2, wherein, the respective pieces of baggage from each respective passenger are received more than about 12 hours before a respective scheduled departure time of a respective flight on which each respective passenger is to fly;

4. The method of claim 1, wherein step (a) includes receiving the piece of baggage at a station operated by a commercial transport business enterprise.

5. The method of claim 4, wherein the commercial transport business enterprise operates a commercial ground shipping business, and a first agent of the commercial ground shipping business performs step (d).

6. The method of claim 1, wherein step (d) includes delivering the scanned pieces of baggage to a security checkpoint at each airport.

7. The method of claim 6, wherein the security checkpoint is dedicated to receiving the delivered baggage.

8. The method of claim 1, further comprising securing the baggage at the airport between completion of step (c) and a time at which each respective item of baggage is loaded.

9. An airport method, comprising the steps of:
(a) receiving a plurality of pieces of baggage at an airport from one or more passengers by way of an off-airport site, wherein the respective pieces from each respective passenger have been received at the off-airport site more than about 12 hours before a respective scheduled departure time of a respective flight on which that passenger is to fly, and every one of the received plurality of pieces of baggage has been previously scanned for tracking; and
(b) storing the plurality of pieces of baggage in a compartment of an airplane separate from a compartment used to store bags that are checked in at the airport.

10. The method of claim 9, further comprising:
providing an express gate at the airport for the passengers to whom the plurality of previously scanned pieces of baggage belong.

11. The method of claim 10, further comprising:
allowing the passengers to whom the plurality of previously scanned pieces of baggage belong to arrive at the express gate between about 45 minutes and about 60 minutes before the respective scheduled departure time of a respective flight on which that passenger is to fly.

12. The method of claim 9, further comprising:
removing at least one of the plurality of previously scanned pieces of baggage from the separate area or compartment at a hub airport before removing any of the bags that were checked in at the first airport; and
transferring the at least one previously scanned piece of baggage to an airplane servicing a second leg of a connecting flight.

13. The method of claim 9, further comprising:
removing at least one of the plurality of previously scanned pieces of baggage from the separate area or compartment at a destination airport before removing any of the bags that were checked in at the first airport.

14. The method of claim 1, wherein the commercial shipping business is an express or overnight delivery service.
